(19) United States
(12) Patent Application Publication
(10) Pub. No.: US 2008/0101446 A1
(43) Pub. Date: May 1, 2008

(54) MULTI-MODEM SCHEDULING ON A COMMUNICATION DEVICE

(75) Inventors: Roberto Gautier, Davie, FL (US); James R. Wise, Monroe, NC (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/555,039

(22) Filed: Oct. 31, 2006

(51) Int. Cl. H04L 5/16

(52) U.S. Cl. 375/222

(57) ABSTRACT

A method of managing a plurality of modems within a communication device can include determining that a plurality of modems within the communication device will concurrently transmit a network response to a received page (415). A modem selection value for each of the plurality of modems can be calculated (425). A time at which one or more of the plurality of modems transmits a network response can be modified according to the modem selection values of the plurality of modems (440).

### BACKGROUND OF THE INVENTION

1. Field of the Invention

The present invention generally relates to communication devices that have a plurality of modems and, more particularly, to managing the operation of the modems.

2. Background of the Invention

Many modern communication devices incorporate multiple modems to facilitate communication over more than one network. For example, some mobile stations, such as those available from Motorola, Inc. of Schaumburg, Ill., have begun to offer mobile stations capable of communicating over CDMA and iDEN networks. (Motorola and iDEN are trademarks of Motorola, Inc. in the United States, other countries, or both).

Other examples of communication devices having multiple modems can include mobile stations that communicate over mobile phone network(s) as well as over one or more short range wireless networks such as an IEEE 802 wireless network or a Bluetooth® wireless network. Mobile stations typically include Bluetooth modems for communicating with wireless peripheral devices such as earpieces and the like. The various modems within the communication device often operate concurrently and independently of one another.

Incorporating multiple modems within a single communication device can create significant power demands upon the battery. Each additional modem increases the power requirements of the device. Under normal circumstances, increased power demands are not problematic in terms of battery life. The current draw that occurs when more than one modem is active at the same time, however, can, in some cases, be so significant that the useful life of the battery is reduced.

### SUMMARY OF THE INVENTION

One aspect of the present invention relates to a method of controlling modems of a communication device having a plurality of modems. The method can include determining that a plurality of modems within the communication device will concurrently transmit a network response to a received page and calculating a modem selection value for each of the plurality of modems. A time at which one or more of the modems transmits a network response can be modified according to the modem selection values of the plurality of modems.

Calculating a modem selection value can include computing the modem selection value for each modem of the plurality of modems according to a page type for the page to which each respective modem of the plurality of modems is to respond. The modem selection values further can be computed according to a page weight that is set according to the page type of the page to which each respective modem of the plurality of modems is to respond. Modem selection values also can be computed according to a modem type for each respective modem of the plurality of modems and/or a modem weight that is set according to the modem type of each of the plurality of modems.

Calculating a modem selection value further can include computing the modem selection value for each modem of the plurality of modems according to a number of times the page, to which each respective modem of the plurality of modems is to respond, will be transmitted by a network that sent the page. The modem selection value also can be computed according to a re-transmit time offset of a network that sent the page for each respective modem of the plurality of modems.

In one arrangement, the modem selection value for a selected modem “n” of the plurality of modems can be computed according to (PTₙ*PWₙ)+(Mₙ*MWₙ)−(NTₙ*NRTₙ), where PTₙ denotes a page type of the page received by the selected modem, PWₙ is a weight of the page that is set according to the page type, Mₙ indicates a type of the selected modem, MWₙ indicates a weight assigned to the selected modem, NTₙ indicates a number of times a network that sent the page to the selected modem will transmit the page, and NRTₙ indicates a re-transmit time offset for the network that sent the page to the selected modem.

The time at which one or more of the plurality of modems transmits a network response can be modified by delaying a network response of a modem of the plurality of modems having a lower modem selection value to allow another modem of the plurality of modems having a higher modem selection value to transmit a network response. The time at which one or more of the plurality of modems transmits a network response also can be modified by sequentially enabling one of the plurality modems at a time while disabling each of the other ones of the plurality of modems according to decreasing modem selection values to allow the enabled modem to transmit a network response.

In the event that two or more modems of the plurality of modems have equal modem selection values, the method can include delaying a network response from the modem of the two modems that has a higher retransmission factor to allow the other modem of the two modems to transmit a network response.

Another aspect of the present invention relates to a communication device. The communication device can include a plurality of modems that communicate with different communication networks and a controller. The controller can be coupled to each of the plurality of modems and selectively enable different ones of the plurality of modems to transmit a network response according to assigned modem selection values such that, responsive to a received page, the plurality of modems do not concurrently transmit network responses.

The controller can calculate the modem selection value for each of the plurality of modems according to a page type of a page to which each respective modem of the plurality of modems is to respond or a weight assigned to each page according to the page type. The controller also can calculate the modem selection value for each of the plurality of modems according to a modem type for each respective modem of the plurality of modems, or a modem weight for each respective modem of the plurality of modems. Modem weight can be assigned according to modem type.

The controller can calculate the modem selection value for each of the plurality of modems according to a number of times a page, to which each respective modem of the plurality of modems is to respond, will be transmitted or a re-transmit time offset of the network that sent the page to which each respective modem of the plurality of modems is to respond.

In another arrangement, the controller can calculate a modem selection value for a selected modem “n” of a plurality of modems of the communication device having received a page according to (PTₙ*PWₙ)+(Mₙ*MWₙ)−(NTₙ*NRTₙ) where PTₙ denotes a page type for the page that was received by the selected modem, PWₙ is a weight of the page that is set according to page type, Mₙ indicates a type of the selected modem, MWₙ indicates a weight assigned to the selected modem, NTₙ indicates a number of times a network will transmit the page to the selected modem, and NRTₙ indicates a re-transmit time offset for the network that sent the page to the selected modem.

The controller can modify a time at which at least one of the plurality of modems transmits a network response according to the assigned modem selection values. The controller further can delay a network response of a modem of the plurality of modems having a lower modem selection value to allow another modem of the plurality of modems having a higher modem selection value to transmit a network response. In another arrangement, the controller can sequentially enable one of the plurality modems at a time while disabling each of the other ones of the plurality of modems according to decreasing modem selection values to allow the enabled modem to transmit a network response.

Another aspect of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communication device that is useful for understanding the present invention;

FIG. 2 depicts another aspect of the communication device of FIG. 1 which is useful for understanding the present invention;

FIG. 3 depicts exemplary message flows which are useful for understanding the present invention;

FIG. 4 is a flowchart that is useful for understanding the present invention; and

FIG. 5 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to managing and/or controlling modems in a communication device that includes a plurality of modems. Within such a device, operation of the modems can be controlled and arbitrated such that the modems are not concurrently active. More particularly, modems that receive a page from a network can be identified and scheduled so that the responses provided by each of the various modems of the communication device do not occur at the same time. The response from each respective modem can be scheduled so that one modem responds after another modem responds and no overlap occurs between the responses. Arbitrating when the modems respond to network inquiries can avoid the situation in which more than one modem is responding concurrently, which can adversely affect the useful life of a battery.

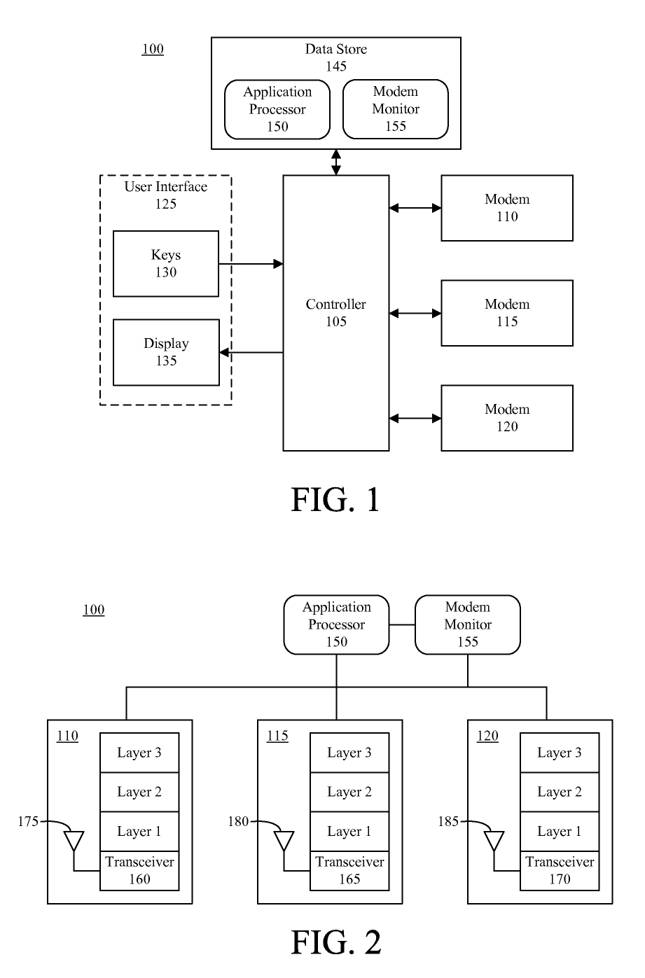

FIG. 1 depicts a block diagram of a communication device 100 that is useful for understanding the present invention. As shown, the communication device 100 can include a controller 105, a plurality of modems 110, 115, and 120, a user interface 125, as well as a data storage device (data store) 145. The communication device 100 can be any of a variety of different devices that have a plurality of modems, i.e., a computer system with multiple modems, a portable information processing system, such as a personal digital assistant, having a plurality of modems, or a mobile station having a plurality of modems. The particular type of device is not intended to limit the present invention so long as the device is configured to function with more than one modem as described herein.

The controller 105 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. These components can be coupled together to perform various processing functions as described herein.

The modems 110-120, as known, can modulate and demodulate signals to convert signals from one form to another for transmission over various communication networks (not shown). Each of the modems 110-120 can be configured to communicate over a different communication channel or protocol, as the case may be. In one aspect, the modem 110 can communicate data via IEEE 802 wireless communications, for example, 802.11 and 802.16 (WiMax), WPA, or WPA2. The modem 115, can communicate data via GSM, TDMA, CDMA, WCDMA, or direct wireless communication. Modem 120 can communicate data via TCP/IP.

Fewer or additional modems can be included within the communication device 100. For example, one or more additional modems can be included which communicate data over short range wireless communication links such as Bluetooth. It should be appreciated that the particular number of modems included within the communication device 100 is not intended to limit the present invention so long as the communication device 100 includes more than one modem. Further, the particular communication networks and protocols listed herein have been provided for purposes of illustration only and are not intended to limit the present invention.

The user interface 125 can include one or more keys 130 which can be disposed within a keypad, one or more programmable keys, or both. A programmable key refers to a key that can be used to initiate any of a variety of different programmatic actions within the communication device 100 according to the particular operating state in which the communication device 100 is disposed at the time the programmable key is actuated or activated. The user interface 125 also can include a display 135. Other mechanisms (not shown) for obtaining user input and providing feedback to a user can be provided in the user interface 125. For example, the communication device 100 can include various sensors, audio input and output transducers, etc.

The data store 145 can include one or more storage devices, each of which can include a magnetic storage medium, an electronic storage medium, an optical storage medium, a magneto-optical storage medium, and/or any other storage medium suitable for storing digital information. In one arrangement, the data store 145 can be integrated into the controller 105. In any case, the data store 145 can include, or store, an operating system (not shown), which can be executed by the controller 105. The data store 145 further can include an application processor 150 and a modem monitor 155. The application processor 150 and the modem monitor 155 can be implemented as computer programs that can be executed by the controller 105. The application processor 150 and the modem monitor can execute within the application layer of the communication device 100. The application processor 150, when executed by the controller 105, can perform the various functions and methods described herein.

The modem monitor 155 can monitor the state of the modems 110-120. More particularly, the modem monitor 155 can communicate with the modems 110-120 to determine which modems 110-120, if any, have received a page from a network. Upon receiving a page from a network, the modem having received the page typically provides a response. The modem monitor 155 can notify the application processor 150 of the state of the modems 110-120. Accordingly, the application processor 150 can determine that those modems that have received a page from a network will send a response to the respective network.

As known, a page generally refers to an inquiry from a network. A page is indicative of an incoming communication to the communication device 100 and is sent from the network after a communication link has been established between the network and the communication device 100. For example, a page can be sent from a network indicating that a call is being directed to the communication device 100. In that case, the communication device 100 is already “on the network” in the sense that a communication link has previously been established between the network and the communication device 100.

The application processor 150 can communicate with the modem monitor 155 and the modems 110-120 to arbitrate between the modems 110-120. More particularly, the application processor 150 can schedule when each of the respective modems 110-120, that have received a page, will respond. The response from each of the modems 110-120 can be coordinated by the application processor 150 in such a way that none of the responses overlap one another. That is to say, the responses provided by the modems 110-120 do not occur concurrently.

In operation, the modem monitor 155 can continually monitor the modems 110-120 to determine which modems have received a page from a network and provide that information to the application processor 150. If more than one modem has received a page for which a response is to be sent, the application processor 150 can determine a schedule that the modems 110-120 will follow when sending the responses. In general, the application processor 150 can delay the response of one or more of the modems 110-120 according to a modem selection value that is calculated by the application processor 150 for each respective modem that has received a page and is in contention for responding.

FIG. 2 depicts an aspect of the communication device of FIG. 1 which is useful for understanding the present invention. More particularly, FIG. 2 illustrates a more detailed view of the application processor 150, the modem monitor 155, and the modems 110-120. Each of the modems 110-120 can include a transceiver 160, 165, and 170 and an antenna 175, 180, and 185, respectively as shown. Further, each modem 110-120 can include multiple layers of control software, i.e., layer 1, layer 2, and layer 3, as specified by the Open Systems Interconnection (OSI) reference model, where layers 1, 2, and 3 correspond to the physical, data link, and network layers respectively. It should be appreciated, however, that the complexity of the implementation can vary according to design constraints, the implementer, and/or other considerations.

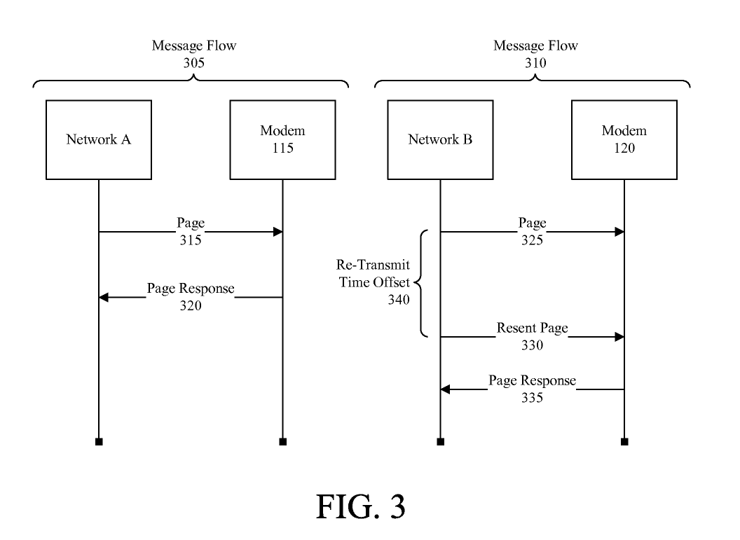

FIG. 3 depicts exemplary message flows which are useful for understanding the present invention. Two message flows, referenced as message flow 305 and message flow 310, are shown. Both message flows 305 and 310 are transacted with a same communication device such as the communication device described with reference to FIG. 1. Message flow 305 takes place with a particular modem, e.g., modem 115, of the communication device; and message flow 310 takes place with another modem, e.g., modem 120, of the communication device.

For purposes of illustration, modem 115 can be a modem that communicates over a short range wireless communication network such as Bluetooth. Modem 120 can be a modem that communicates over a CDMA network. As noted, additional modems can be included and the particular number of modems within the communication device is not intended to limit the present invention. Modem 125 has been excluded for purposes of illustration.

As shown, a page 315 can be sent from network A to modem 115. At or about the same time, a page 325 can be sent from network B to modem 120. Each of the modems 115 and 120 can provide status information to the modem monitor (not shown), which in turn can provide information to the application processor (not shown). The modems 115 and 120 can provide operating state information to the modem monitor from time-to-time, periodically, responsive to a state change such as receiving a page, or responsive to a query from the modem monitor. The application processor can determine that modems 115 and 120 will be responding at or about the same time to pages 315 and 325 respectively. Modem 115 and 120 can operate independently of one another unless the application processor arbitrates between the two.

It should be appreciated that the particular time at which modem 115 and modem 120 receive pages 315 and 325 respectively need not be identical. For example, in one aspect, the application processor can include logic which determines that if pages 315 and 325 are received within a predetermined amount of time of one another, a likelihood exists that the response from each respective modem, without arbitration by the application processor, will overlap in time. That is, modem 115 and modem 120 will be sending responses at or about the same time, or concurrently.

In another arrangement, an internal timer can be set for modem 115 when page 315 is received that expires at time “t+x”. If modem 120 receives page 325 at time “t” and is going to respond at time “t+x”, the application processor can determine which of modems 115 or 120 has the higher priority or whether one modem must respond to avoid a dropped link, such as in the case of a Bluetooth beacon.

The application processor can arbitrate between modem 115 and modem 120 causing modem 120 to delay its response to network B. Thus, as shown, modem 115 provides a page response 320 to network A. Modem 120, rather than proceeding with a page response to network B after modem 115 has completed the transmission of page response 320, can await a further page, referred to as a resent page 330, from network B. In response to the resent page 330, the modem 120 can send a page response 335 to network B.

In this example, the application processor can be aware of the number of times network B is configured to resend pages when no response is received from the communication device being paged. Further the application processor can be programmed with a re-transmit time offset 340 in reference to the amount of time between when page 325 and resent page 330 is sent from network B. It should be appreciated that the communications device can be programmed with a re-transmit time offset for each network with which the communication device is able to communicate. Accordingly, the application processor can determine that if modem 120 does not respond to page 325, and instead awaits a further inquiry from network B, e.g., resent page 330, modem 115 will have completed transmission of page response 320 by that time. Modem 120, responding to resent page 330, can transmit without overlapping with the transmission from modem 115.

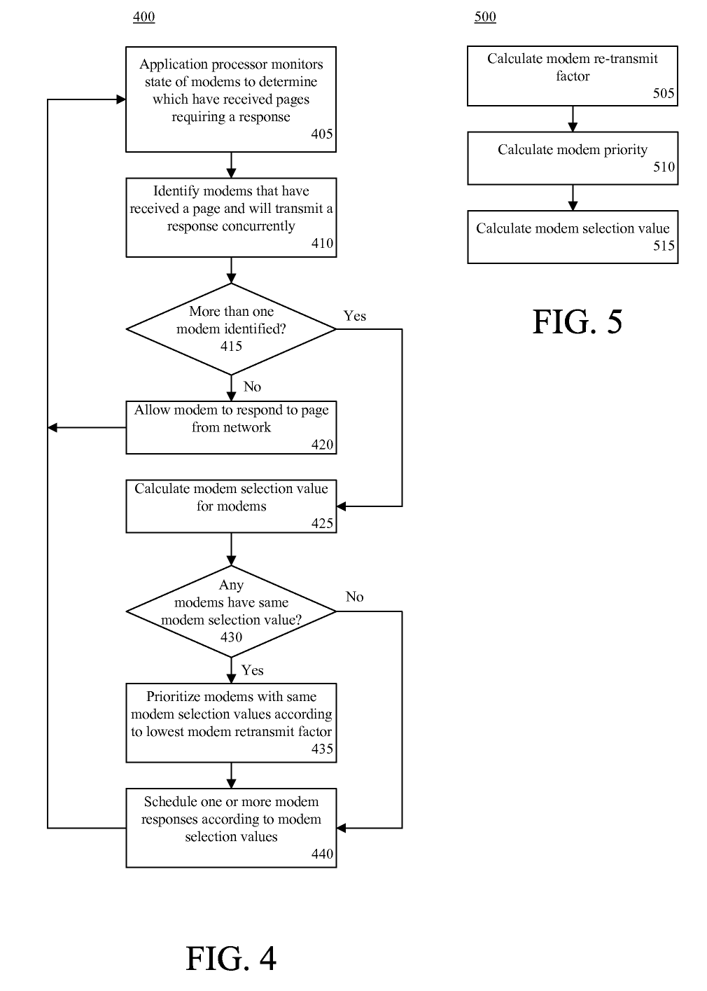

FIG. 4 is a flowchart presenting a method 400 that is useful for understanding the present invention. The method 400 can be performed by a communication device such as the device described with reference to FIG. 1. The method 400 can begin in step 405 where the application processor monitors the state of modems to determine which modems have received pages requiring a response. The operating state of a modem can be provided to the application processor via the modem monitor. As used herein, the operating state of a modem can include, but is not limited to, information indicating whether the modem has received a page, the time such a page was received, the type of page received, the particular modem of the communication device that received the page, and the like.

In step 410, the application processor can identify modems that have received a page and that will transmit a response to the page concurrently. As noted, in one aspect, such a determination can be made by identifying those modems that have received a page, for which a response has not yet been sent, within a predetermined amount of time of one another.

In step 415, a determination can be made as to whether more than one modem was identified in step 410. If more than one modem was identified, the application processor can determine that two or more modems are in contention for responding to the received pages in a manner that will overlap, i.e., concurrently. In that case, the method can proceed to step 425. If only one modem was identified, the method can proceed to step 420. In step 420, the application processor can allow the modem to respond to the page from the network without interference. That is, the application processor can determine that there is no need for arbitration among modems and the modem can respond to the page in a conventional manner. After step 420, the method can loop back to step 405 to continue processing.

Continuing with step 425, the application processor can calculate a modem selection value for each of the modems identified in step 410. Calculation of the modem selection value will be described herein in greater detail with reference to FIG. 5. In general, the modem selection values can be determined according to various quantities relating to the operating state of the modems, attributes of the networks that have paged the modems, and the like. In step 430, a determination can be made by the application processor as to whether any modems have a same modem selection value. If so, the method can proceed to step 440. If not, the method can proceed to step 435.

In step 435, the set of modems that have a same modem selection value can be prioritized among themselves according to a modem re-transmit factor. The modem re-transmit factor, which will be described in further detail with reference to FIG. 5, is a measure that is calculated with reference to the number of times a network is configured to re-transmit a page in the event no response is received from the communication device to which the page was sent and the re-transmit time offset used by that network. The modems can be prioritized such that the modem having the lowest modem re-transmit factor is given the highest priority, or enabled over the others. The modem having the highest modem re-transmit factor can be given the lowest priority of the set.

In step 440, the application controller can schedule, or reschedule, as the case may be, one or more modem responses according to the modem selection values determined in step 430. The modems can be scheduled such that highest priority is given to the modem with the highest modem selection value. Accordingly, the lowest priority can be given to the modem with the lowest modem selection value. Within the order established by the modem selection values, those modems, if any, having the same modem selection value can be prioritized, at least among themselves, according to the modem re-transmit factor for each such modem as determined in step 435.

In general, modems can be permitted to respond in order of decreasing modem selection values. In one arrangement, for example, the modem with the highest modem selection value can be permitted to respond while the other modems are disabled or otherwise prevented from responding. The modem with the next highest modem selection value then can be allowed to respond while the other modems are disabled. The process, i.e., scheduling, can continue as described.

In another arrangement, the application processor can instruct modem(s) “do not respond”. In that case, such modem(s) can refrain from providing a response to a received page. The application processor subsequently can instruct a modem to “respond”, at which time the modem can respond to the page. Such an embodiment can be useful in cases where the application processor determines that the highest priority modem will complete a response prior to the time that a resent page is expected for a lower priority modem that is in contention with the highest priority modem. In that case, rather than waiting the full amount of time for the lower priority modem to receive a resent page, the application processor can instruct the lower priority modem to respond after the highest priority modem has completed transmission of its network response. Further, an instruction to respond can be useful in cases where the modem has received a final or last page from the network and, thus, will not receive a subsequent resent page to trigger a response.

In another aspect, the application processor can provide an instruction to one or more modems indicating “do not respond to this page”. In that case, the modem can refrain from responding to the current page, but respond to a next page without further prompting by the application processor. That is, when the page is resent to the modem due to a non-response condition, the modem will reply to the resent page. In this arrangement, the application controller relies upon the network capability for resending information to the modem and the re-transmit time offset of the network in scheduling the modem responses.

FIG. 5 is a flowchart presenting a method 500 that is useful for understanding another aspect of the present invention. More particularly, FIG. 5 illustrates one technique for determining the modem selection values for modems that are in contention for responding to a page from a network. The method 500 considers various parameters of the network with which the modem is responding as well as aspects of the modem and the type of page that has been received by the modem. In one aspect, FIG. 5 provides a technique for determining modem selection values as discussed in step 425 of FIG. 4. Further, FIG. 5 illustrates one technique for calculating the modem re-transmit factor discussed in step 435 of FIG. 4.

In step 505, the modem re-transmit factor, denoted as Modem_RTF, can be calculated. In one aspect, the modem re-transmit factor for a selected modem “n” can be calculated as Modem_RTFₙ=NTₙ*NRTₙ, where NTₙ can indicate the number of times a network transmitting a page to modem “n” will transmit the page in the event no response is received from the communication device, and NRTₙ indicates the re-transmit time offset for network sending the page to modem “n”. The values for NTₙ and NRTₙ can be pre-programmed into the communication device, i.e., as part of the application processor for the various networks with which the communication device can communicate. Thus, when a modem receives a page from a specified network, the parameters for that network, in terms of NTₙ and NRTₙ are known by the application processor.

In another arrangement, the communication device can be configured to query the network for the parameters needed to compute Modem_RTF. Since the parameters are typically network configurable, the parameters can change from time to time and under different circumstances. The communication device can query the network for the parameters. When a response from the network is received, the communication device can update the parameters stored therein according to the most recent parameters provided from the network.

In step 510, a modem priority, denoted as Modem_PR can be calculated. In one aspect the modem priority for the selected modem “n” can be calculated as Modem_PRₙ=(PTₙ*PWₙ)+(Mₙ*MWₙ), where PTₙ refers to a page type for a page received by the modem from the network that sent the page and PWₙ refers to a predetermined page weight that is assigned to the page. The page weight can be assigned according to page type. Mₙ can indicate the particular modem of the communication device that received the page, and MWₙ can refer to a predetermined weight assigned to the modem MTₙ. The page type parameter PWₙ allows the application processor to distinguish between pages received for calls as compared to pages received for text messages or other communications, for example. Different page types, relating to different forms of communication, can be distinguished. Each of these page types can be assigned a weight. Thus, pages for calls can be given more weight, i.e., considered more important, than pages for text messages.

Similarly, the modem parameter Mₙ, which indicates the particular modem for which the modem selection value is being calculated, allows the application processor to distinguish among the modems. The modem weight parameter MWₙ allows the application processor to weight the modems of the communication device differently in terms of importance. Thus, the modem for communicating via Wimax, for example, can be given greater weight and importance than a modem configured for CDMA, or vice versa. The values needed to calculate Modem_PR, like those needed to calculate Modem_RTF, can be programmed into the communication device and/or the application processor.

In step 515, a modem selection value for the selected modem “n” can be calculated by summing the modem re-transmit factor Modem_RTFₙ with the modem priority Modem_PRₙ. Accordingly, the modem selection value, denoted as Modem_SEL, for a given modem “n” can be expressed as Modem_SELₙ=Modem_RTFₙ+Modem_PRₙ. This further can be expressed in expanded form as Modem_SELₙ=(PTₙ*PWₙ)+(MTₙ*MWₙ)−(NTₙ*NRₙ). It should be appreciated that the method 500 can be performed for each respective modem that is considered to be in contention for responding as discussed with reference to FIG. 4.

In another aspect, values calculated for modem selection as illustrated in FIG. 4 can be pre-programmed into the communication device in the form of a lookup table or other data structure. In that case, the application processor need not perform a real-time calculation for the values, but rather locate the proper modem selection value from the data structure.

In yet another aspect, the various weights discussed with reference to FIG. 5 can be varied according to the operating state of the communication device. In this manner, different modems can be favored and different page types can be favored according to the particular state in which the communication device is disposed. This allows the application processor to dynamically adjust to the environment in which the communication device is operated.

The embodiments disclosed herein are directed to managing and coordinating the operation of multiple modems within a communication device. The time at which various modems in the communication device respond to network inquiries can be varied and managed according to a combination of network parameters, modem parameters, and the type of inquiry, or page, that is received by the modems. Arbitrating when the modems respond to a page can avoid the situation in which more than one modem is concurrently responding, or active concurrently, which can adversely affect battery life.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. Within a communication device, a method of managing a plurality of modems comprising:
determining that a plurality of modems within the communication device will concurrently transmit a network response to a received page;
calculating a modem selection value for each of the plurality of modems; and
modifying a time at which at least one of the plurality of modems transmits a network response according to the modem selection values of the plurality of modems.

2. The method of claim 1, wherein calculating a modem selection value further comprises computing the modem selection value for each modem of the plurality of modems according to a page type for the page to which each respective modem of the plurality of modems is to respond.

3. The method of claim 2, wherein calculating a modem selection value further comprises computing the modem selection value for each modem of the plurality of modems according to a page weight that is set according to the page type of the page to which each respective modem of the plurality of modems is to respond.

4. The method of claim 1, wherein calculating a modem selection value further comprises computing the modem selection value for each modem of the plurality of modems according to a modem type for each respective modem of the plurality of modems.

5. The method of claim 4, wherein calculating a modem selection value further comprises computing the modem selection value for each modem of the plurality of modems according to a modem weight that is set according to the modem type of each of the plurality of modems.

6. The method of claim 1, wherein calculating a modem selection value further comprises computing the modem selection value for each modem of the plurality of modems according to a number of times the page, to which each respective modem of the plurality of modems is to respond, will be transmitted by a network that sent the page.

7. The method of claim 1, wherein calculating a modem selection value further comprises computing the modem selection value for each modem of the plurality of modems according to a re-transmit time offset of a network that sent the page to each respective modem of the plurality of modems.

8. The method of claim 1, wherein calculating a modem selection value further comprises computing the modem selection value of a selected modem “n” of the plurality of modems according to (PTₙ*PWₙ)+(Mₙ*MWₙ)−(NTₙ*NRTₙ), where PTₙ denotes a page type of the page received by the selected modem, PWₙ is a weight of the page that is set according to the page type, Mₙ indicates a type of the selected modem, MWₙ indicates a weight assigned to the selected modem, NTₙ indicates a number of times a network that sent the page to the selected modem will transmit the page, and NRTₙ indicates a re-transmit time offset for the network that sent the page to the selected modem.

9. The method of claim 1, wherein modifying a time at which at least one of the plurality of modems transmits a network response further comprises delaying a network response of a modem of the plurality of modems having a lower modem selection value to allow another modem of the plurality of modems having a higher modem selection value to transmit a network response.

10. The method of claim 1, wherein modifying a time at which at least one of the plurality of modems transmits a network response further comprises sequentially enabling one of the plurality modems at a time while disabling each of the other ones of the plurality of modems, according to decreasing modem selection values, to allow the enabled modem to transmit a network response.

11. The method of claim 1, wherein if two or more modems of the plurality of modems have equal modem selection values, modifying a time at which at least one of the plurality of modems transmits a network response further comprises delaying a network response from the modem of the two modems that has a higher retransmission factor to allow the other modem of the two modems to transmit a network response.

12. A communication device comprising:
a plurality of modems that communicate with different communication networks; and
a controller coupled to each of the plurality of modems, wherein the controller selectively enables different ones of the plurality of modems to transmit a network response according to assigned modem selection values such that, responsive to a received page, the plurality of modems do not concurrently transmit network responses.

13. The communication device of claim 12, wherein the controller further calculates the modem selection value for each of the plurality of modems according to a page type of a page to which each respective modem of the plurality of modems is to respond or a weight assigned to each page according to the page type.

14. The communication device of claim 12, wherein the controller further calculates the priority for each of the plurality of modems according to a modem type for each respective modem of the plurality of modems or a modem weight for each respective modem of the plurality of modems that is assigned according to modem type.

15. The communication device of claim 12, wherein the controller further calculates the modem selection value for each of the plurality of modems according to a number of times a page, to which each respective modem of the plurality of modems is to respond, will be transmitted by a network or a re-transmit time offset of the network that sent the page to which each respective modem of the plurality of modems is to respond.

16. The communication device of claim 12, wherein the controller further calculates a modem selection value for a selected modem “n” of a plurality of modems of the communication device having received a page according to (PTₙ*PWₙ)+(Mₙ*MWₙ)−(NTₙ*NRTₙ), where PTₙ denotes page type for the page received by the selected modem, PWₙ is a weight of the page that is set according to page type, Mₙ indicates a type of the selected modem, MWₙ indicates a weight assigned to the selected modem, NTₙ indicates a number of times a network that sent the page to the selected modem will transmit the page, and NRTₙ indicates a re-transmit time offset for the network that sent the page to the selected modem.

17. The communication device of claim 12, wherein the controller modifies a time at which at least one of the plurality of modems transmits a network response according to the assigned modem selection values.

18. The communication device of claim 12, wherein the controller delays a network response of a modem of the plurality of modems having a lower modem selection value to allow another modem of the plurality of modems having a higher modem selection value to transmit a network response.

19. The communication device of claim 12, wherein the controller sequentially enables one of the plurality modems at a time while disabling each of the other ones of the plurality of modems according to decreasing modem selection values to allow the enabled modem to transmit a network response.

20. A machine readable storage, having stored thereon a computer program having a plurality of code sections for managing a plurality of modems of a communication device, the machine readable storage comprising:
code that determines that a plurality of modems within the communication device will concurrently transmit a network response to a received page;
code that calculates a modem selection value for each of the plurality of modems; and
code that modifies a time at which at least one of the plurality of modems transmits a network response according to the modem selection values of the plurality of modems.
